(19) United States
(12) Patent Application Publication
(10) Pub. No.: US 2025/0294610 A1
(43) Pub. Date: Sep. 18, 2025

(54) Staggered Time Slots for Access Attempts

(71) Applicant: Telefonaktiebolaget LM Ericsson (publ), Stockholm (SE)

(72) Inventors: Leif Wilhelmsson, Lund (SE); Rocco Di Taranto, Lund (SE); Miguel Lopez, Solna (SE); Dennis Sundman, Sollentuna (SE)

(21) Appl. No.: 18/860,424

(22) PCT Filed: Apr. 26, 2022
(86) PCT No.: PCT/EP2022/061032

§ 371 Date: Oct. 25, 2024

(51) Int. Cl. H04W 74/0816; H04W 74/0833; H04W 84/12

(52) U.S. Cl. CPC H04W 74/0816; H04W 74/0858; H04W 84/12

(57) ABSTRACT

A wireless communication device determines a set of non-adjacent time slots. In at least one of the time slots from the set, the wireless communication device attempts to access a wireless channel shared with one or more other wireless communication devices.

### TECHNICAL FIELD

The present invention relates to methods for controlling wireless transmissions and to corresponding devices, systems, and computer programs.

### BACKGROUND

In wireless communication technologies, there is an increased interest in using unlicensed bands, like the 2.4 GHZ ISM frequency band, the 5 GHz frequency band, the 6 GHz frequency band, and the 60 GHz frequency band using more advanced channel access technologies. Historically, WLAN (Wireless Local Area Network) technology based on the IEEE 802.11 standards family, also denoted as Wi-Fi, has been the dominant standard in unlicensed bands, specifically for applications requiring support for high data rates, e.g., mobile broadband (MBB) applications. The WLAN technology is specified in “IEEE Standard for Information technology—Telecommunications and information exchange between systems Local and metropolitan area networks—Specific requirements—Part 11: Wireless LAN Medium Access Control (MAC) and Physical Layer (PHY) Specifications,” IEEE Std 802.11-2020, in the following also denoted as “IEEE 802.11 standard”.

Due to the large available bandwidth in the unlicensed band, the WLAN (Wireless Local Area Network) technology based on the IEEE 802.11 standards family provides a very simple distributed channel access mechanism based on a so-called distributed coordination function (DCF).

Distributed channel access means that a device, in IEEE 802.11 terminology known as a station (STA), tries to access the wireless channel when it has data to send. Effectively there is no difference in channel access whether the station is an access point (AP) or a non-access point STA (non-AP STA). DCF works well as long as the channel load is not too high. When the load is high, and in particular when the number of stations trying to access the wireless channel is large, channel access based on DCF does not work well. The reason for this is that there will be a high probability of collision on the channel, leading to poor channel usage and to unpredictable and often rather high latency.

A default channel access mechanism used in current WLAN systems is referred to as enhanced distributed channel access (EDCA) and is specified in the IEEE 802.11 standard. In the EDCA channel access mechanism, the STA accesses the channel using a set of channel access parameters based on a traffic class of the data. The wireless channel is obtained for a time duration denoted as TXOP (transmit opportunity), in which multiple frames of the same data class may be transmitted. The maximum size of a TXOP depends on the data type. A typical duration of a TXOP is in the range of a few milliseconds.

To improve channel access predictability, in particular if there is a large number of STAs operating on the same channel, a more centralized channel access may be utilized. Such centralized channel access may involve that rather than letting a STA access the channel whenever it has data to send, the channel access is controlled by the AP. A corresponding channel access scheme is for example supported in the IEEE 802.11ax technology, see IEEE 802.11ax-2021—IEEE Standard for Information technology—Telecommunications and information exchange between systems Local and metropolitan area networks—Specific requirements Part 11: Wireless LAN Medium Access Control (MAC) and Physical Layer (PHY) Specifications Amendment 1: Enhancements for High Efficiency WLAN (May 2021), in the following denoted as “IEEE 802.11ax amendment” or High Efficiency (HE) amendment. The IEEE 802.11ax technology, or HE technology, for example supports orthogonal frequency division multiple access (OFDMA) in both downlink (DL), i.e., in a direction from the AP to the STA, and uplink (UL), i.e., in a direction from the STA to the AP. Also multi-user (MU) transmission in form of multi-user multiple input multiple output (MU-MIMO) is supported for both the DL and the UL. By supporting MU transmission and letting the AP control the channel access within a cell, efficient channel usage is achieved and one can avoid collisions arising due to contention in the cell, in the IEEE 802.11 terminology also referred to as basic service set (BSS).

A concept aiming at further improving performance of WLAN systems, is coordinated operation of APs in sharing a TXOP. For example, when assuming that there are two or more APs in range of each other and using the same channel, each of these APs would normally contend for the channel, and the AP that wins the contention would then reserve a TXOP on the channel. The other APs would have to defer from channel access until the TXOP ends. Then each of the APs could again contend for access to the channel. This may also have the effect that the channel access by a certain AP becomes rather unpredictable, which may in turn cause difficulties in ensuring latency requirements or other QoS (Quality of Service) requirements. Such issues may be alleviated by allowing the APs to share the reserved TXOP in a coordinated manner.

For example one possible form of coordinated sharing of a TXOP is denoted as Coordinated OFDMA (COFDMA). In COFDMA, two or more APs contend for the channel, and the winning one reserves a TXOP on, e.g., a 40 MHz channel bandwidth. The AP exchanges information with the other APs and shares the resources of the TXOP. For example, if there are two APs, denoted as AP1 and AP2, and AP1 wins the contention for channel access, AP1 could assign the lower 20 MHz of the channel bandwidth to itself and the upper 20 MHz of the channel bandwidth to AP2. If AP2 wins the contention, it could assigns the upper 20 MHz of the channel bandwidth to itself and the lower 20 MHz of the channel bandwidth to AP1. Accordingly, each of the APs could transmit or receive on the channel during both TXOPs, irrespective which of the AP wins the contention for access to the channel. the way of sharing the TXOP can be dynamically adapted from one TXOP to the next, so that the channel can be utilized in an efficient manner. COFDMA is for example described in “Gain Analysis of Coordinated AP Time/Frequency Sharing in a Transmit Opportunity in 11be”, by Lochan Verma et al., available online under “https://mentor.ieee.org/802.11/dcn/19/11-19-1879-00-00be-coordinated-ap-time-and-frequency-sharing-gain-analysis.pptx” (2019).

Even when using more advanced channel access schemes like COFDMA, the channel access is still based on contention an requires some kind of LBT (Listen Before Talk) mechanism, so that a STA will only transmit after the channel was assessed to be free. This still causes unpredictability due to a non-negligible risk of collision. This may specifically be the case if multiple APs have agreed to cooperate by coordinated TXOP sharing and all contend for the channel. This may for example result in situations where two of the APs gain channel access at the same time, which may then lead to a collision.

Accordingly, there is a need for techniques which allow for improving predictability of channel access in contention based systems, especially in situations with coordinated APs.

### SUMMARY

According to an embodiment, a method of controlling wireless transmissions in a wireless communication system is provided. According to the method, a wireless communication device determines a set of non-adjacent time slots. In at least one of the time slots from the set, the wireless communication device attempts to access a wireless channel shared with one or more other wireless communication devices.

According to a further embodiment, a wireless communication device for a wireless communication system is provided. The wireless communication device is configured to determine a set of non-adjacent time slots. Further, the wireless communication device is configured to, in at least one of the time slots from the set, attempt to access a wireless channel shared with one or more other wireless communication devices.

According to a further embodiment, a wireless communication device for a wireless communication system is provided. The wireless communication device comprises at least one processor and a memory. The memory contains instructions executable by said at least one processor, whereby the wireless communication device is operative to determine a set of non-adjacent time slots. Further, the memory contains instructions executable by said at least one processor, whereby the wireless communication device is operative to, in at least one of the time slots from the set, attempt to access a wireless channel shared with one or more other wireless communication devices.

According to a further embodiment, a computer program or computer program product is provided, e.g., in the form of a non-transitory storage medium, which comprises program code to be executed by at least one processor of a wireless communication device. Execution of the program code causes the wireless communication device to determine a set of non-adjacent time slots. Further, execution of the program code causes the wireless communication device to, in at least one of the time slots from the set, attempt to access a wireless channel shared with one or more other wireless communication devices.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2 schematically illustrates an example of a scenario with colliding channel access attempts.

FIG. 3 schematically illustrates an example of controlling channel access attempts according to an embodiment.

FIG. 4 schematically illustrates a further example of controlling channel access attempts according to an embodiment.

FIG. 5A schematically illustrates an example of a channel access procedure according to an embodiment.

FIG. 5B schematically illustrates a further example of a channel access procedure according to an embodiment.

FIG. 6 shows a flowchart for schematically illustrating a method according to an embodiment.

FIG. 7 shows a block diagram for schematically illustrating functionalities of a wireless communication device according to an embodiment.

FIG. 8 schematically illustrates structures of an access point according to an embodiment.

FIG. 9 schematically illustrates structures of a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

According to the illustrated concepts, a wireless communication device limits its access attempts on a wireless channel to certain time slots. In particular, the wireless communication device determines a set of non-adjacent time slots and performs its access attempts in one or more of the time slots from the set. Because the time slots are non-adjacent, time slots left between the time slots of the set are available for access attempts by other wireless communication devices, without causing excessive delay to such access attempts and without unduly increased risk of colliding access attempts. The access attempts may thus be organized in a staggered manner. On the other hand, the access attempts are assumed to be triggered locally at each wireless communication device, and when considering the overall picture of all wireless communication devices which may attempt to access the wireless channel, may be regarded as “random”. In the following, the access to the wireless channel by the wireless devices will therefore also be termed as “random access” (RA).

The wireless communication devices which attempt to reserve the channel may include APs and non-AP STAs. The time slots may be defined based according to a certain granularity, e.g., of 1 μs. The time slots may be defined as a uniform grid in which each time slot has the same duration. However, variable slot durations of the time slots could be used as well. The time slots may for example be identified by respective slot indices. In some cases, the access attempts may be based on a contention window (CW) and the duration of the time slots may correspond to a step-size of counting down a random backoff delay within the CW. The indices of the time slots may be counted from a time slot in which the wireless channel changes from being assessed as occupied to being assessed as idle. However, other ways of identifying or labelling the time slots could be used as well, using a specific signal as reference, such as a beacon, or labelling the time slots based on absolute time of the day.

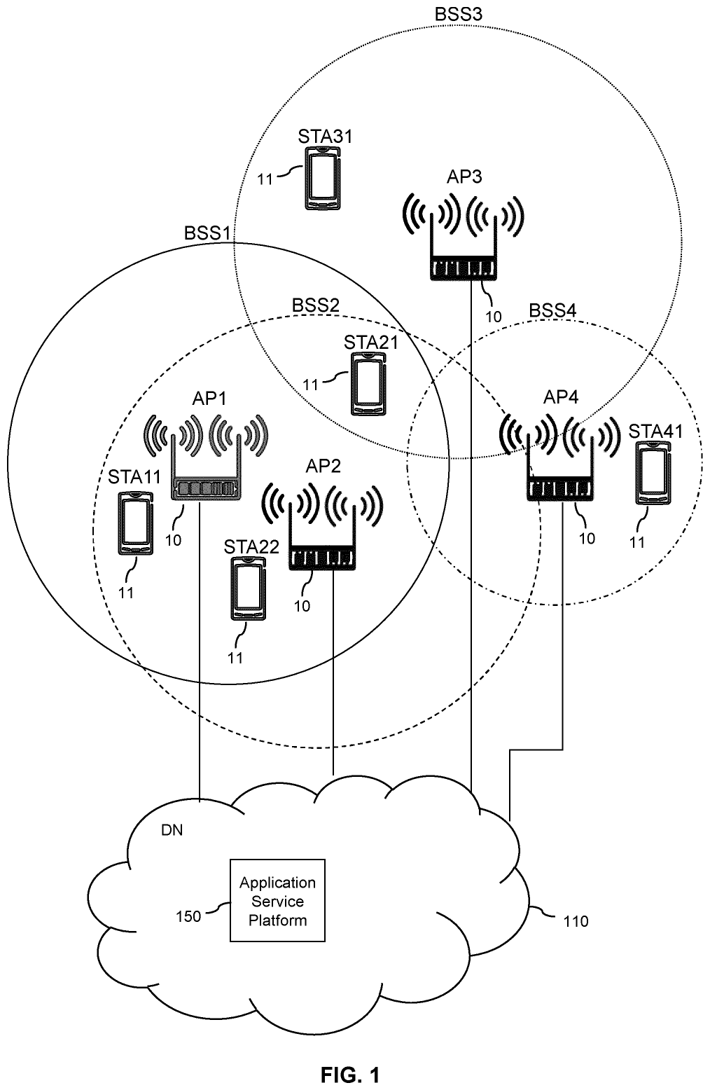

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA12, STA21, STA22, STA31, and STA41. STA11 and STA12 are served by AP1 (in a first BSS denoted as BSS1), STA21 and STA22 are served by AP2 (in a second BSS denoted as BSS2), STA31 is served by AP3 (in a third BSS denoted as BSS3), and STA41 is served by AP4 (in a fourth BSS denoted as BSS4). The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed or license-exempt band like the 2.4 GHz ISM band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 1 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

In the illustrated concepts, at least some of the APs 10 and their associates stations 11 may use the same wireless channel based on some form of RA scheme. The staggering of the access attempts by using non-adjacent time slots assigned to a certain AP 10, stations 11, or group of stations 11 or APs 10 allows for avoiding a risk of colliding access attempts without unduly delaying access attempts. Scenarios as explained in the following may for example involve that stations 11 associated with an AP 10 use a RA scheme with staggered access attempts according to the illustrated concepts when transmitting data to the AP 10. Other scenarios may involve that APs 10 operating on the same wireless channel use a RA scheme with staggered access attempts according to the illustrated concepts when transmitting to their associated stations 11. The latter case may also involve that, in response to a successful access attempt, one of the APs 10 reserves a TXOP on the wireless channel. In some cases, the RA scheme may involve that, before transmitting on the wireless channel, the AP 10 or station 11 performs an LBT procedure to assess whether the wireless channel is occupied. The LBT procedure may be based on sensing the wireless channel. Examples of such LBT procedure include CSMA/CA (Carrier Sense Multiple Access/Collision Avoidance). But other kinds of LBT procedure could be used as well. In some cases, the RA scheme could also involve performing the access attempt without any LBT procedure, which will herein also be denoted as “pure RA”.

In the following examples it is assumed that, if applied, the LBT procedure involves that the device which intends to access the wireless channel generates a random number within a CW and then decrements this random number by one at predetermined time steps. These time steps define time slots of a certain duration. The random number determines for how many time slots the device shall wait until it is allowed to transmit on the wireless channel. The time delay corresponding to the random number is in the following denoted as back-off (BO). A BO counter may be used for the above-mentioned decrementing of the random number.

In some cases, RA may be performed on a dedicated RA channel, which is exclusively used for RA, and not for transmission of data. A dedicated RA channel is typically used in wireless communication systems operated in a licensed frequency band, such as cellular networks based on the LTE technology or NR technology specified by 3GPP. When using a dedicated RA channel, the device which intends to transmit may start a transmission on the RA channel as soon as the BO counter reaches zero. There may be a risk that the BO counter of another device reaches zero at the same time, resulting in a collision of access attempts and typically of transmission failure by both devices. The probability of such collision can be reduced by increasing the size of the CW. However, a large CW also means that there is a higher probability of selecting a large value for the BO counter, resulting in increased channel access delay. Such issues may to some degree be addressed by using an exponential BO. In the case of exponential BO, initially a small CW is used, so that it is possible to access the wireless channel with small channel access delay. In the case of a collision, e.g., as detected based on a lost data packet or other type of transmission failure, the size of the CW is increased for a retransmission attempt, with the aim of reducing the probability of collision for the retransmission. Typically, the size of the CW is doubled up until a maximum CW size is reached.

In other cases, the RA may be performed on the same channel as used for transmission data, without using a dedicated RA channel. This is for example the case for many wireless communication systems operating in license exempt bands, like WLAN based on the IEEE 802.11 standard or a network based on the NR-U (Next Generation in Unlicensed bands) technology specified by 3GPP. When the RA is on a channel also used for transmission of data, initiating a transmission as soon as the BO counter reaches zero may have a rather high risk of a collision with an ongoing data transmission. To avoid such risk, an LBT procedure may be used to assess whether the channel is occupied or idle, and the BO counter decremented only if the channel is assessed as being idle. This means that the BO counter is frozen as long as the channel is assessed as being occupied. It is noted, that even when using an LBT procedure, there may be a residual risk of colliding transmissions since two devices could perform the LBT-based RA access at the same time so that their BO counters reach zero at the same time.

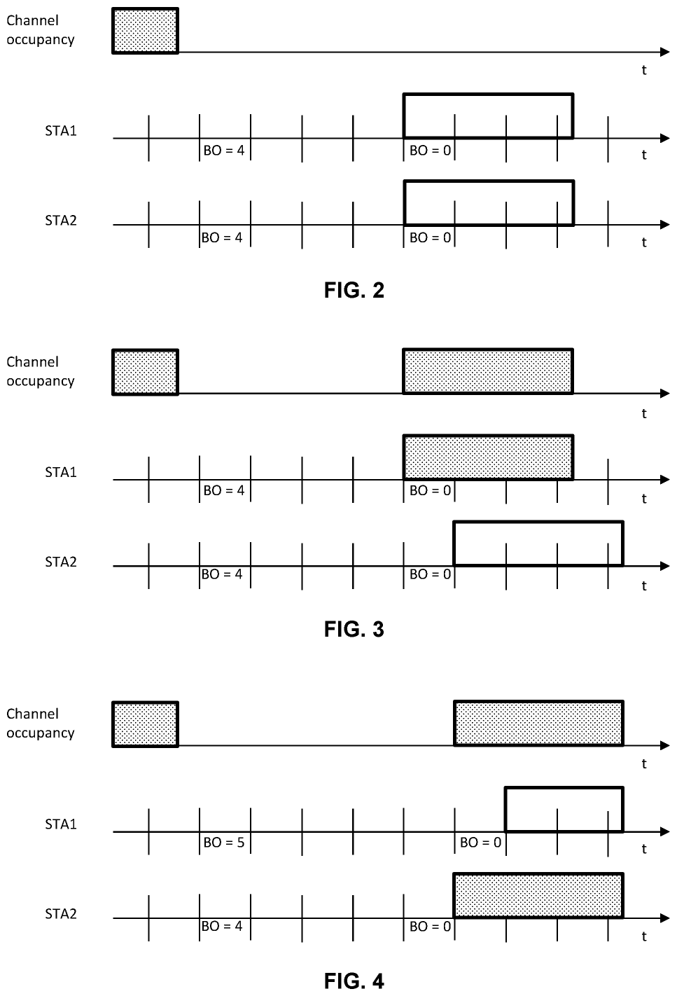

In the illustrated concepts, excessive delay of a RA can be avoided while at the same time keeping the risk of colliding access attempts low, by requiring that the access attempt is performed in one of the non-adjacent time slots. The basic principles of the illustrated concepts are illustrated by FIGS. 2, 3, and 4, which illustrate channel occupancy and transmit activity as a function of time (t) in exemplary scenarios involving two stations, denoted as STA1 and STA2, which operate on the same wireless channel. FIG. 2 shows a comparative scenario assuming a conventional RA scheme, in which STA1 and STA2 coincidentally draw the same random number when initiating an access attempt after the channel becomes idle. In the example of FIG. 2, the random number drawn by STA1 and STA2 is four. As illustrated, the BO counter of STA1 and the BO counter of STA2 are decremented by one with each time slot in which the wireless channel is assessed as being idle. At some point, both BO counters both reach zero. Since the wireless channel is still idle, STA1 and STA2 attempt channel access at in the same time slot, which results in a collision.

FIG. 3 illustrates a first example in which the RA is performed in accordance with the illustrated concepts, to avoid a collision of the RA by STA1 with the RA by STA2. In the example of FIG. 3, it is assumed that STA1 and STA2 have agreed that STA1 is allowed to attempt a transmission only in the time slots with odd index, whereas STA2 is allowed to attempt a transmission only in the time slots with even index. Here, the index of the time slots may be counted from the time slot in which, after being occupied, the wireless channel is first found to be idle. A set of time slots with odd index is thus assigned to STA1 and a set of time slots with even index is assigned to STA2. These two sets of time slots each consist of a sequence of non-adjacent time slots, and the time slots of the two sets are interleaved so that adjacent time slots are assigned to different STAs. In the example of FIG. 3, the BO counters of STA1 and STA2 reach zero in a time slot with odd index. Accordingly, STA1 is allowed to transmit while STA2 has to wait until a time slot with even index and thus defers its transmission attempt for one more time slot. However, since STA2 needs to perform the LBT procedure before transmitting on the wireless channel, it will detect that the wireless channel has become occupied due to the transmission by STA1. STA2 will thus further defer its transmission attempt until the wireless channel becomes idle again. A collision of access attempts by STA1 and STA2 is avoided. It is noted that the RA scheme applied in the example of FIG. 3 can be regarded as being fair when the STA1 and STA2 draw different random numbers. In this case, the STA with the smallest random number wins the contention and gains access to the wireless channel. Fairness is also provided if STA1 and STA2 draw the same random number. In that case, the STA winning the contention depends on whether the random number is even, like in the example of FIG. 3, or odd, which can be expected to happen with about the same likelihood.

Further, it is noted that additional delays which may occur due to the limitation of usable time slots is kept small. In the example of FIG. 3, there is no additional delay, because STA1 can immediately transmit when its BO counter reaches zero. However, it could also happen that a STA is not immediately allowed to transmit when its BO counter reaches zero, because it has to wait until the next time slot where it is allowed to attempt transmitting, even if immediately transmitting when the BO counter reaches zero would not have resulted in a collision. FIG. 4 illustrates an example of a corresponding situation. In the example of FIG. 4, STA1 and STA2 draw random numbers when the wireless channel becomes idle. The random number drawn by STA1 is assumed to be 5, and the random number drawn by STA2 is assumed to be 4. This has the effect that STA2 will win the contention. However, the BO counter of STA2 reaches zero in a time slot with odd index, so that STA2 needs to wait until the next time slot before it is allowed to transmit. In FIG. 4, it can be seen that in the time slot when STA2 is allowed to transmit, also the BO counter of STA1 reaches zero. However, since this time slot has an even index, STA1 is not allowed to transmit, and collision of access attempts by STA1 and STA2 is thus avoided.

As can be seen, with the illustrated concepts it becomes possible to avoid collision of access attempts without excessive delays. The basic principles as explained in connection with FIGS. 3 and 4 for two STAs can be extended to higher numbers of STAs. For example, if the number of considered STAs is N, each STA could be allowed to attempt access to the wireless channel only in every N-th time slot, with the time slots assigned to the different STAs being offset with respect to each other so that adjacent time slots are assigned to different STAs.

In some scenarios, fairness of channel access could be further improved by permuting the assignment of time slots to the STAs after each contention. In the example explained in connection with FIGS. 3 and 4, STA1 and STA2 could agree that for a certain contention the time slots with odd index are assigned to STA1 and the times slots with even index are assigned to STA2, while in the next contention the time slots with even index are assigned to STA1 and the times slots with odd index are assigned to STA2.

The agreement which time slots are assigned to a certain STA may be based on various kinds of signaling, e.g., on direct negotiation between the STAs and/or based on signaling from the AP to which the STAs are associated, e.g., in an association request-response frame exchange.

The illustrated concepts may also be useful in scenarios with overlapping BSS (OBSS), where not all STAs contending for the wireless channel belong to the same BSS. In such scenarios, it is beneficial to ensure alignment of boundaries of the time slots for all STAs contending for the wireless channel, as for example illustrated in FIGS. 3 and 4. If STAs belong to the same BSS, alignment of the time slot boundaries may be present in an implicit manner, because in a WLAN system according to the IEEE 802.11 standard the STAs in an infrastructure BSS are synchronized to a common clock. Each STA keeps a local timer and a timing synchronization function (TSF) keeps synchronization of the timers for all the STAs in one BSS, with the AP of the BSS acting as a timing master. The resolution of the TSF timer is typically 1 μs.

However, in OBSS scenarios it could also happen that the time slot boundaries of STAs in different BSS are non-aligned. In such cases, the APs of the different BSSs may perform inter-BSS synchronization to provide alignment of the time slot boundaries also between STAs in the different BSSs. For this purpose, an AP may infer the time slot boundaries in an OBSS from the beacons transmitted by another AP. For this purpose, each AP could transmit beacons announcing the value of the AP's TSF to other STAs. Based on such beacons, several APs belonging to OBSSs could tune their respective clocks to provide alignment of the time slot boundaries within a given tolerance threshold. The TSF may then ensure that all STAs in all BSSs share the same time slot boundaries, within the given tolerance.

In some scenarios, it is also possible that APs of different BSSs cooperate by coordinated sharing of TXOPs. In such cases, one of the cooperating APs may be selected as timing master. The other APs may then adjust their respective clocks so that the time slot boundaries are aligned within the desired tolerance. In some cases, synchronization among APs can be achieved without explicit coordination signaling between the APs. For example, if there are three APs and each AP synchronizes to the strongest beacon from the other APs, it can be expected that this will converge to a situation where all APs will be mutually synchronized. When there are many APs within range of each other it might however not be feasible to synchronize all the APs. Rather, it may be preferable to organize the APs in clusters of synchronized APs. This could for example be achieved by implementing a rule according to which each AP may synchronize only to the neighboring with the highest received signal strength of the beacon.

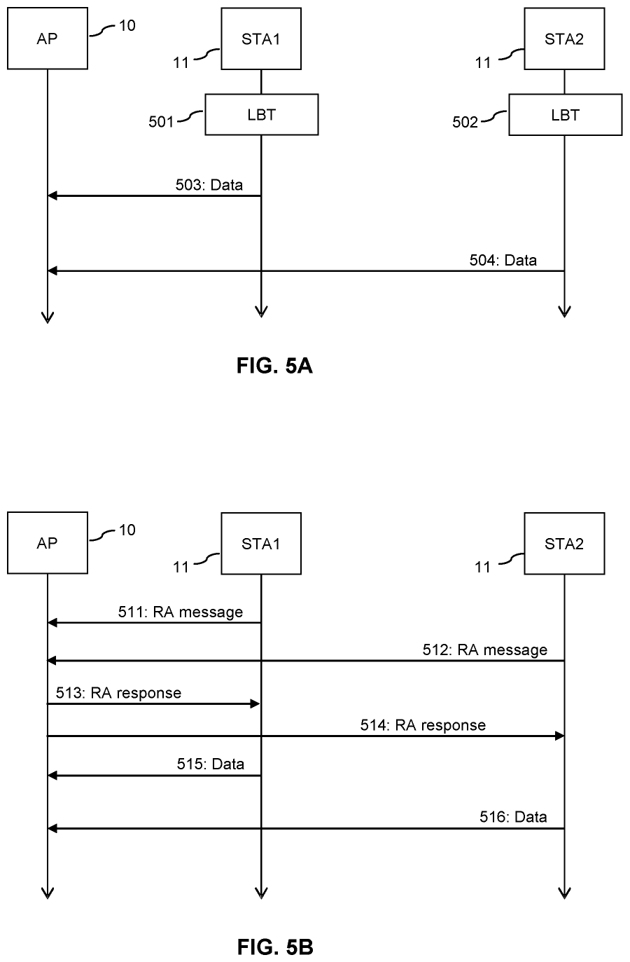

FIGS. 5A and 5B illustrate exemplary RA processes which may be controlled in accordance with the illustrated concepts. The processes involve an AP 10, a first station 11 associated with the AP 10, denoted as STA1, and a second station 11 associated with the AP 10, denoted as STA2. In these examples, it is assumed that each of STA1 and STA2 intends to send data to the AP 10 and thus perform RA to a wireless channel.

In the example of FIG. 5A, STA1 and STA2 each perform an LBT procedure to assess whether the wireless channel is occupied, as illustrated by blocks 501, 502. In the illustrated example, it is assumed that the wireless channel is found to be idle at the same time, so that STA1 and STA2 are both allowed to transmit on the wireless channel. In accordance with the illustrated concepts, the corresponding attempts to access the wireless channel are performed in different time slots, so that in a first time slot STA1 sends a wireless transmission of data 503 to the AP 10, and subsequently, in a second time slot STA2, sends a wireless transmission of data 503 to the AP 10. As explained above, the first time slot could be a time slot with odd index, and the second time slot a time slot with even index. Collision of the two wireless transmissions is avoided without causing excessive delay to the wireless transmissions.

In the example of FIG. 5B, STA1 and STA2 each send a respective RA message 511, 512 to the AP 10. In the illustrated example, it is assumed that the RA messages 511, 512 do not collide with each other and also do not collide with any other transmission on the wireless channel. So the RA messages 511, 512 are successfully received by the AP 10. In response to the RA messages 511, the AP 10 sends a respective RA response 513 to STA1, and in response to the RA message 512, the AP 10 sends a respective RA response 514 to STA2. The RA response 513 may for example indicate resources of the wireless channel that are allocated to STA1, and the RA response 514 may for example indicate resources of the wireless channel that are allocated to STA2. Based on the RA response 513, STA1 sends a wireless transmission of data 515 to the AP 10, and based on the RA response 514, STA2 sends a wireless transmission of data 516 to the AP 10. In accordance with the illustrated concepts, an attempt of STA1 to access the wireless channel to transmit the RA message 511 and an attempt of STA2 to access the wireless channel to transmit the RA message 512 are performed in different time slots, so that in a first time slot STA1 sends the RA message 511, and subsequently, in a second time slot, STA2 sends the RA message 512. As explained above, the first time slot could be a time slot with odd index, and the second time slot a time slot with even index. Collision of the two RA messages 511, 512 is avoided without causing excessive delay to the access attempts and subsequent transmissions of data.

In the example of FIG. 5B, usage of an LBT procedure by STA1 and STA2 before sending the RA message 511, 512 is not required. Rather, STA1 and STA2 can implicitly infer from the received RA response 513, 514 that there was no collision of the RA messages 511, 512. It is however noted that it would of course also be possible to supplement the processes of FIG. 5B with an LBT procedure performed by each of STA1 and STA2 before sending the respective RA message 511, 512.

Accordingly, the illustrated concepts may be applied in connection with various kinds of RA procedures. Some of such RA procedures may require that a STA performs an LBT procedure before attempting to transmit on the wireless channel, while in other cases such LBT procedure could be omitted. Further, in some cases the RA procedure may involve that the STA initiates the RA by first sending an RA message. The RA message may be a rather short control message which has the purpose of initiating a subsequent transmission of data. Because the RA message is relative short, it has lower risk of collision than a regular transmission of data. However, since regular transmissions of data can be controlled based on the initial RA message, e.g., by allocating resources for the transmission of data, collisions can also be avoided for the transmissions of data.

In some scenarios, the illustrated concepts may thus involve that RA is performed without doing an assessment of whether the channel is idle or not, i.e., without any LBT procedure. This may also be referred to as “pure RA”. A pure RA may for example be used when there is a dedicated RA channel which is not shared with transmissions of data. The probability of collision is then determined by the duration of an RA message and the frequency of occurrence of RA attempts. An unsuccessful RA attempt may be detected by lack of a response to the RA message. When an RA attempt is unsuccessful, the CW may be increased in order to reduce the probability that also the next RA attempt suffers from a collision.

In the case of pure RA, the devices operating on the wireless channel may be allocated different time slots in a similar way as explained above. The duration of the time slots where the device is allowed to start a transmission may be selected based on the duration of the RA message. For example, the duration of the time slots could be equal to the duration of the RA message. In this way, it can be avoided that transmission of a RA messages by different devices collide.

If the number of devices operating on the wireless channel is large, in may become infeasible to allocate dedicated time slots to each device. Rather, the allocation of the time slots to the devices may be done in such a way that a set of non-adjacent time slots is assigned to a group of devices, and that different sets of non-adjacent slots are assigned to different groups. Accordingly, the total number of devices may be split into a number of N groups. The number of devices that could attempt transmission at the same time is thus reduced by a factor of N.

It is noted that in accordance with the illustrated concepts the assignment of the time slots to the groups is done in such a way that a different set of non-adjacent time slots is assigned to each of the groups, and the different sets are interleaved. This has the benefit of avoiding excessive delays of access attempts by a certain group.

Further, in some scenarios the illustrated concepts may be applied in connection with an RA procedure requiring that a device that intends to transmit on the wireless channel first performs an LBT procedure before it is allowed to transmit on the wireless channel. Also in this case, a sufficiently small number of devices operating on the wireless channel may allow for assigning a dedicated set of non-adjacent time slots to each of the devices, thereby allowing to completely avoid collisions. In the case of larger number of devices operating on the wireless channel, the allocation of the time slots to the devices may be done in such a way that a set of non-adjacent time slots is assigned to a group of devices, and that different sets of non-adjacent slots are assigned to different groups. Accordingly, the total number of devices may be split into a number of N groups. The number of devices that could attempt transmission at the same time is thus reduced by a factor of N. Again, the assignment of the time slots to the groups would be done in such a way that a different set of non-adjacent time slots is assigned to each of the groups, and the different sets are interleaved. This has the benefit of avoiding excessive delays of access attempts by a certain group.

In some cases, the allocation of time slots may be such that N different time slots are allocated to N different devices or to N different groups of devices. However, in some cases in may also be beneficial to deviate from such uniform allocation, e.g., in order to prioritize certain devices or groups of devices. For example, more time slots could be allocated to a device with higher priority.

Further, the above-mentioned groups of devices could differ in size, e.g., depending on delay requirements. If all devices operating on the wireless channel have similar delay requirements, the groups of devices may have equal sizes. If there are different delay requirements, the groups may be formed in such a way that the devices with stricter delay requirements are assigned to smaller groups than the devices with more relaxed delay requirements. Such scenarios with different group sizes may also include the case that there are one or more groups with only one device, which thus has a dedicated set of non-adjacent slots and can operate in a collision free manner. Other groups may in turn include multiple devices, and for these devices there is some residual risk of collision.

As mentioned above, in some cases the illustrated concepts may be applied in connection with a RA procedure that uses a BO counter and an LBT procedure. One example of a corresponding RA procedure is the EDCA mechanism of the IEEE 802.11 standard. In the EDCA mechanism, there are four priority classes with increasing priority rating: background traffic, best effort traffic, video traffic, and voice traffic. These priority classes have different parameters for interframe spacing and selection of BO counters. In the illustrated concepts, these priority classes could be considered in the following manner: For background traffic, access to the wireless channel is allowed four time slots after the BO counter reaches zero; for best effort traffic, access to the wireless channel is allowed three time slots after the BO counter reaches zero; for video traffic, access to the wireless channel is allowed two time slots after the BO counter reaches zero; and for voice traffic access to the wireless channel is allowed one time slot after the BO counter reaches zero. An additional offset of one or more timeslots may be added to consider the above-mentioned set of non-adjacent time slots that is assigned to the considered device or group of devices. As a result, collision between the priority classes may be avoided, while collisions of transmissions of the same priority class from different devices could still occur. It is noted that other or additional priority classes could be considered in a corresponding manner. For example, time-sensitive networking (TSN) traffic could be defined as an additional priority class having the highest priority and thus be allowed to access the wireless channel after the smallest number of time slots.

In some scenarios, the RA access procedure could also take into account the possibility that two or more APs coordinate their transmissions to share TXOP. In such case, the two or more APs first contend for the wireless channel. The AP that wins the contention reserves a TXOP and invites the other AP(s) to share the TXOP. The sharing of the TXOP may be based on assigning different time resources of the TXOP to each of the APs, which is also referred to as coordinated TDMA (Time Division Multiple Access), or be based on assigning different frequency resources of the TXOP to each of the APs, which is also referred to as coordinated OFDMA (Orthogonal Frequency Division Multiple Access). The coordinated sharing of the TXOP may allow to achieve more predictable channel access and less delays. In the illustrated concepts, the cooperating APs may operate as described above when contending for access to the wireless channel to reserve the TXOP: Each of the APs may be allocated a different set of non-adjacent time slots, and when an AP wins the contention and reserves the TXOP, it will transmit in one of the time slots of its allocated set. In this way, it can be avoided that two or more of the cooperating APs simultaneously attempt reserving a TXOP on the wireless channel, so that collisions can be avoided. The allocation of the different sets of time slots may be based on various kinds of signaling among the APs, e.g., signaling for preparation of the cooperation by the APs. Such signaling does not need to be performed for each shared TXOP, but could rather be performed on a longer time scale, e.g., in association with beacons transmitted by the APs.

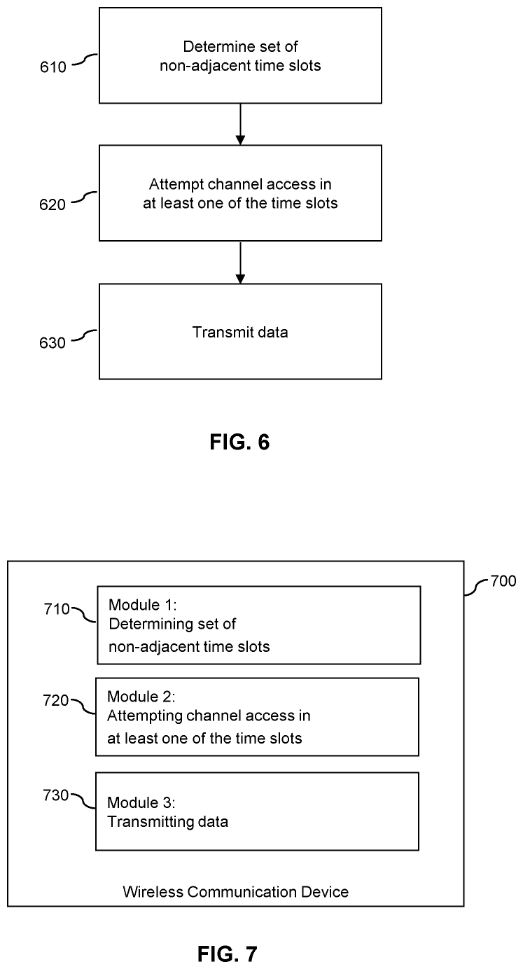

FIG. 6 shows a flowchart for illustrating a method of controlling wireless transmissions in a wireless communication system, which may be utilized for implementing the illustrated concepts. The method of FIG. 6 may be used for implementing the illustrated concepts in a wireless communication device that operates on a wireless channel. The wireless channel is shared with one or more other wireless communication devices. In some scenarios, the wireless channel may be usable for data transmissions by the wireless communication device and the one or more other wireless communication devices. In other scenarios, the wireless channel may be a dedicated RA channel.

In some scenarios, the wireless communication device can be an AP of the wireless communication system, e.g., one of the above-mentioned APs 10. In other scenarios, the wireless communication device could be a non-AP STA, e.g., one of the above-mentioned stations 11. The wireless communication system may be based on a WLAN technology, e.g., according to the IEEE 802.11 standards family.

If a processor-based implementation of the wireless communication device is used, at least some of the steps of the method of FIG. 6 may be performed and/or controlled by one or more processors of the wireless communication device. Such wireless communication device may also include a memory storing program code for implementing at least some of the below described functionalities or steps of the method of FIG. 6.

At step 610, the wireless communication device determines a set of non-adjacent time slots. The time slots may be defined based on various kinds of time grid. The time-slots being non adjacent means that, for each time slot of the set, the neighboring time slots are not part of the set. For example, the time slots could be identified by indices, and the set could consist either of the time slots having an odd index or of the time slots having an even index. The set of non-adjacent time slots is defined based on a numbering of the time slots. In some cases, the set of non-adjacent time slots may be defined with respect to a time slot in which the wireless channel is first assessed as being unoccupied, e.g., by starting to count the indices or some other numbering scheme from that time slot.

In some cases, the set of non-adjacent time slots consists of every N-th time slot, with N being an integer number greater than 1. Here, N may depend on a number of wireless communication devices that are expected to contend for access to the wireless channel. For example, N may be a non-decreasing function of the number of wireless communication devices expected to contend for access to the wireless channel, more specifically an increasing function of the number of wireless communication devices expected to contend for access to the wireless channel.

If the wireless communication device is one of multiple APs cooperating in sharing the wireless channel, N may depend on a number of the cooperating APs.

In some scenarios, N may depend on a traffic category of data to be transmitted by the wireless communication device. The above-mentioned priority classes are examples of such traffic categories.

The set of non-adjacent time slots may differ from time slots allowed to be used by at least one of the one or more other wireless communication devices when attempting to access the wireless channel.

In some scenarios, the wireless communication device determines the set of non-adjacent time slots based on signaling from at least one of the one or more other wireless communication devices. For example, the wireless communication device could determine the set of non-adjacent time slots based on negotiation with at least one of the one or more other wireless communication devices.

At step 620, the wireless communication device attempts to access the wireless channel in at least one of the time slots from the set. The attempt to access the wireless channel may involve that the wireless communication device start a wireless transmission on the wireless channel.

In some scenarios, step 620 may involve that the wireless communication devices attempts to access the wireless channel in at least one of the time slots from the set after, based on sensing the wireless channel, assessing the wireless channel as being unoccupied, e.g., by performing an LBT procedure. FIG. 5A illustrates an example of such LBT based RA procedure. The sensing of the wireless channel may be performed for a random-based number of time slots, e.g., as indicated by a BO counter. A window for drawing the random-based number of time slots may be increased in response to the wireless communication device encountering a collision when attempting to access the wireless channel.

In some cases, step 620 may involve that the wireless communication device attempts to access the wireless channel in at least one of the time slots from the set in response to determining that an RA message from the wireless communication device did not experience collision, e.g., as explained in connection with FIG. 5B. In such cases, the duration of the time slots may depend on transmission duration of the RA message.

At step 630, the wireless communication device may transmit data based on the channel access attempt of step 620. In some cases, the channel access attempt of step 620 may involve that the wireless device starts a wireless transmission on the wireless channel. This wireless transmission could then convey the data conveyed at step 630. In other cases, the channel access attempt of step 620 may involve that the wireless device sends an RA message to initiate another wireless transmission. This other wireless transmission may be on another wireless channel, e.g., on a data channel. The data transmitted at step 630 may then be conveyed by the other wireless transmission initiated by the RA message.

FIG. 7 shows a block diagram for illustrating functionalities of a wireless communication device 700 which operates according to the method of FIG. 6. The wireless communication device 700 may correspond to one of the above-mentioned APs 10 or to one of the above-mentioned stations 11. As illustrated, the wireless communication device 700 may be provided with a module 710 configured to determine a set of non-adjacent time slots, such as explained in connection with step 610. Further, the wireless communication device 700 may be provided with a module 720 configured to attempt accessing a wireless channel, such as explained in connection with step 620. Further, the wireless communication device 700 may be provided with a module 730 configured to transmit data, such as explained in connection with step 630.

It is noted that the wireless communication device 700 may include further modules for implementing other functionalities, such as known functionalities of an AP or non-AP STA in an IEEE 802.11 technology. Further, it is noted that the modules of the wireless communication device 700 do not necessarily represent a hardware structure of the wireless communication device 700, but may also correspond to functional elements, e.g., implemented by hardware, software, or a combination thereof.

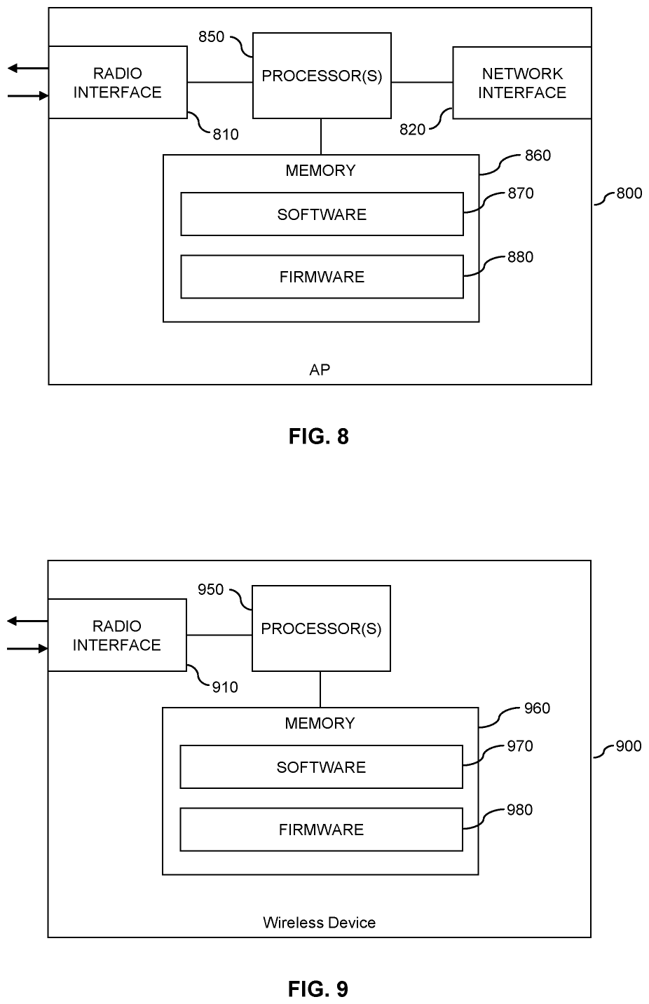

FIG. 8 illustrates a processor-based implementation of an AP 800. The structures as illustrated in FIG. 8 may be used for implementing the above-described concepts. The AP 800 may for example correspond to one of above-mentioned APs 10.

As illustrated, the AP 800 includes a radio interface 810. The radio interface 810 may for example be based on a WLAN technology, e.g., according to an IEEE 802.11 family standard. However, other wireless technologies could be supported as well, e.g., the LTE technology or the NR technology. Further, the AP 800 is provided with a network interface 820 for connecting to a data network, e.g., using a wire-based connection.

Further, the AP 800 may include one or more processors 850 coupled to the interfaces 810, 820, and a memory 860 coupled to the processor(s) 850. By way of example, the interfaces 810, 820, the processor(s) 850, and the memory 860 could be coupled by one or more internal bus systems of the AP 800. The memory 860 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 860 may include software 870 and/or firmware 880. The memory 860 may include suitably configured program code to be executed by the processor(s) 850 so as to implement the above-described functionalities for controlling access attempts, such as explained in connection with the method of FIG. 6.

It is to be understood that the structures as illustrated in FIG. 8 are merely schematic and that the AP 800 may actually include further components which, for the sake of clarity, have not been illustrated, e.g., further interfaces or further processors. Also, it is to be understood that the memory 860 may include further program code for implementing known functionalities of an AP in an IEEE 802.11 technology. According to some embodiments, also a computer program may be provided for implementing functionalities of the AP 800, e.g., in the form of a physical medium storing the program code and/or other data to be stored in the memory 860 or by making the program code available for download or by streaming.

FIG. 9 illustrates a processor-based implementation of a wireless device 900. The structures as illustrated in FIG. 9 may be used for implementing the above-described concepts. The wireless device 900 may for example correspond to one of above-mentioned stations 11. The wireless device 900 may correspond to a non-AP STA.

As illustrated, the wireless device 900 includes a radio interface 910. The radio interface 910 may for example be based on a WLAN technology, e.g., according to an IEEE 802.11 family standard. However, other wireless technologies could be supported as well, e.g., the LTE technology or the NR technology.

Further, the wireless device 900 may include one or more processors 950 coupled to the interface 910 and a memory 1260 coupled to the processor(s) 950. By way of example, the interface 910, the processor(s) 950, and the memory 960 could be coupled by one or more internal bus systems of the wireless device 1200. The memory 960 may include a ROM, e.g., a flash ROM, a RAM, e.g., a DRAM or SRAM, a mass storage, e.g., a hard disk or solid state disk, or the like. As illustrated, the memory 960 may include software 970 and/or firmware 980. The memory 960 may include suitably configured program code to be executed by the processor(s) 950 so as to implement the above-described functionalities for controlling access attempts, such as explained in connection with the method of FIG. 9.

It is to be understood that the structures as illustrated in FIG. 9 are merely schematic and that the wireless device 900 may actually include further components which, for the sake of clarity, have not been illustrated, e.g., further interfaces or further processors. Also, it is to be understood that the memory 960 may include further program code for implementing known functionalities of a non-AP STA in an IEEE 802.11 technology. According to some embodiments, also a computer program may be provided for implementing functionalities of the wireless device 900, e.g., in the form of a physical medium storing the program code and/or other data to be stored in the memory 960 or by making the program code available for download or by streaming.

As can be seen, the concepts as described above may be used for efficiently managing access to a wireless channel shared by multiple wireless communication devices. Collision of RA attempts may be avoided, or the risk of collisions at least reduced, while at the same time avoiding excessive access delays.

It is to be understood that the examples and embodiments as explained above are merely illustrative and susceptible to various modifications. For example, the illustrated concepts may be applied in connection with various kinds of wireless technologies, without limitation to WLAN technologies. Further, the concepts may be also be applied in connection with various kinds of RA procedures. Further, the concepts may be also be applied with respect to any number of devices operating on the same wireless channel. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-24. (canceled)

25. A method, in a wireless communication device, of controlling wireless transmissions in a wireless communication system, the method comprising:
based on assignment of time slots to groups of wireless communication devices such that a different set of non-adjacent time slots is assigned to each of the groups and the different sets are interleaved, determining a set of non-adjacent time slots assigned to the wireless communication device; and
in at least one of the time slots from the set, attempting to access a wireless channel shared with one or more other wireless communication devices after, based on sensing the wireless channel, assessing the wireless channel as being unoccupied.

26. The method of claim 25, wherein the set of non-adjacent time slots consists of every N-th time slot, with N being an integer number greater than 1.

27. The method of claim 26, wherein N depends on a number of wireless communication devices expected to contend for access to the wireless channel.

28. The method of claim 26, wherein N is a non-decreasing function of the number of wireless communication devices expected to contend for access to the wireless channel.

29. The method of claim 26, wherein N is an increasing function of the number of wireless communication devices expected to contend for access to the wireless channel.

30. The method of claim 26, wherein the wireless communication device is one of multiple access points cooperating in sharing the wireless channel and N depends on a number of the cooperating access points.

31. The method of claim 26, wherein N depends on a traffic category of data to be transmitted by the wireless communication device.

32. The method of claim 25, wherein the sensing of the wireless channel is performed for a random-based number of time slots.

33. The method of claim 32, wherein a window for drawing the random-based number of time slots is increased in response to the wireless communication device encountering a collision when attempting to access the wireless channel.

34. The method of claim 25, wherein the wireless communication device attempts to access the wireless channel in the in at least one of the time slots from the set in response to determining that a random access message from the wireless communication device did not experience collision.

35. The method of claim 34, wherein the duration of the time slots depends on transmission duration of the random access message.

36. The method of claim 25, wherein the set of non-adjacent time slots differs from time slots allowed to be used by at least one of the one or more other wireless communication devices when attempting to access the wireless channel.

37. The method of claim 25, wherein the wireless communication device determines the set of non-adjacent time slots based on signaling from at least one of the one or more other wireless communication devices.

38. The method of claim 25, wherein the wireless communication device determines the set of non-adjacent time slots based on negotiation with at least one of the one or more other wireless communication devices.

39. The method of claim 25, wherein the set of non-adjacent time slots is defined based on a numbering of the time slots.

40. The method of claim 25, wherein the set of non-adjacent time slots is defined with respect to a time slot in which the wireless channel is first assessed as being unoccupied.

41. The method of claim 25, wherein the wireless channel is usable for data transmissions by the wireless communication device and the one or more other wireless communication devices.

42. The method of claim 25, wherein the wireless channel is a dedicated random access channel.

43. The method of claim 25, wherein the wireless communication system is based on a Wireless Local Area Network technology according to the IEEE 802.11 standards family.

44. A wireless communication device for a wireless communication system, the wireless communication device comprising:
at least one processor; and
a memory containing program code executable by the at least one processor, the program code being configured such that execution of the program code by the at least one processor causes the wireless communication device to,
based on assignment of time slots to groups of wireless communication devices such that a different set of non-adjacent time slots is assigned to each of the groups and the different sets are interleaved, determine a set of non-adjacent time slots assigned to the wireless communication device, and
in at least one of the time slots from the set, attempt to access a wireless channel shared with one or more other wireless communication devices after, based on sensing the wireless channel, assessing the wireless channel as being unoccupied.
